(19) United States
(12) Patent Application Publication
(10) Pub. No.: US 2012/0330683 A1
(43) Pub. Date: Dec. 27, 2012

(54) EVALUATION OF A SUBJECT'S WEIGHT

(75) Inventors: Mark Ledwidge, Douglas (IE); Kenneth McDonald, Dundrum (IE)

(73) Assignees: CROFTON CARDIAC SYSTEMS LIMITED, Dun Laoghaire, County Dublin (IE); THE NATIONAL DIGITAL RESEARCH CENTRE LIMITED, The Digital Hub, Dublin (IE); UNIVERSITY COLLEGE DUBLIN, Belfield, Dublin (IE); BIANCAMED LIMITED, Belfield, Dublin (IE)

(21) Appl. No.: 13/581,452

(22) PCT Filed: Feb. 25, 2011
(86) PCT No.: PCT/EP11/52788

§ 371 Date: Aug. 27, 2012

(30) Foreign Application Priority Data
Feb. 25, 2010 (IE) S2010/0102

(51) Int. Cl. G06Q 50/24

(52) U.S. Cl. 705/3

(57) ABSTRACT

A method and system for evaluating a subject's weight calculates a moving average of the weight of the subject based on several consecutive weight measurements e.g. on consecutive days. Rather than looking for absolute weight gains of e.g. 2 kg in 48 hours, as with currently accepted guidelines, each new measurement is compared with the calculated moving average, and a first form of alert is generated if the new measurement differs from the calculated moving average by more than a with expected range threshold amount such as by one standard deviation. If the first form of alert is generated consecutively on a predetermined number of successive iterations, a second form of alert is generated different from the first form of alert. The system and method does not assume a stable underlying patient weight, and absolute weight gains over e.g. a 48 hour period are not used as in currently accepted guidelines, which results in earlier alerting of clinical deteriorations and greatly increased sensitivity relative to published guideline methods.

### TECHNICAL FIELD

This invention relates to systems, methods and apparatuses for use in evaluating the weight of a subject. The invention has particular application in the generation of alerts indicative that a subject having a heart condition may require medical intervention.

### BACKGROUND ART

Heart failure is a clinical syndrome in which the heart is unable to produce sufficient blood to satisfy the needs of the body. In most patients the heart failure is “compensated” or stable. However, if the patient becomes unstable, the heart failure causes excess fluid retention which puts additional strain on a weakened heart. Thereafter can follow a vicious cycle of fluid retention and worsening heart failure—sometimes called “decompensation”. This decompensation and clinical deterioration can result in hospitalisation or death if not managed properly.

Accurate diagnosis of clinical deterioration in heart failure can be difficult. Early diagnosis is essential in order to prevent development into overt congestion, which often requires hospitalisation. There is a need for objective measurements to aid early diagnosis in a setting where symptoms may be non-specific and abnormalities on physical examination often subtle and minor. Moreover, any proposed measurements must be evaluated for sensitivity and specificity in this particular setting.

Successive guidelines issued by the European Society of Cardiology and American College of Cardiology/American Heart Association recommend the use of weight gain monitoring to help in this task, with the added advantage that patient self-care is encouraged (see for example “ESC Guidelines for the diagnosis and treatment of acute and chronic heart failure 2008”, Dickstein et al., European Heart Journal (2008) 29, 2388-2442 [doi:10.1093/eurheartj/ehn309], and “ACCF/AHA heart Failure Guidelines”, Hunt et al., Circulation, Apr. 14, 2009, e393-e475 [doi:10.1161/circulationaha.109.192065]). It is advised that an increase of 2 Kg over stable body weight over a period of 48-72 hours should initiate contact with medical or nursing personnel. The pathophysiological basis for this lies in the fact that as the heart decompensates (deteriorates), fluid retention occurs in and around the lungs (pulmonary oedema, pleural effusion respectively), in the region of the abdomen (ascites) and in the ankles and legs (ankle oedema). Accordingly, guidelines recommend that patients should weigh themselves at the same time daily, after voiding and without clothing or shoes.

Other researchers suggest a “3 lb weight gain overnight or 5 lb weight gain over 3 days”. (see “Superior Performance of Intrathoracic Impedance-Derived fluid Index versus Daily Weight monitoring in Heart Failure Patients: Results of the Fluid Accumulation Status Trial (FAST)”, Abraham et al., Journal of Cardiac Failure, Vol.15, No. 9, 2009, p. 813). However, there are few data in the literature assessing the usefulness of weight gain in predicting clinical deterioration and our reported experience is that these thresholds for weight gain are very insensitive.

Although the evidence base for weight gain association with heart failure deterioration is surprisingly limited, a landmark publication by Chaudhry Set al. (Circulation 2007;116;1549-1554; originally published online Sep. 10, 2007) demonstrated that between a population of patients who deteriorated for heart failure reasons and those who did not, significant weight gain was observed in the preceding week. This provides, according to the authors, an opportunity for guideline based remote patient monitoring of weight in heart failure and underlines the potential benefit of a number of commercial approaches used in clinical practice, including those provided by the companies Alere, Philips and Bosch.

It has been shown that weight gain as currently defined by the ESC and ACC guidelines, is very insensitive as a screen for clinical deterioration in heart failure (“Clinical deterioration in established heart failure: What is the value of BNP and weight gain in aiding diagnosis?”, Lewin et al., European Journal of Heart Failure, 7 (2005), 953-957 [doi:10.1016/j.ejheart.2005.06.003]). In this work, an increase of 2 Kg demonstrates high specificity for clinical deterioration in our data on 66 consecutive clinical deteriorations for which weight data were available. In other words, amongst patients who deteriorate, weight gain has low sensitivity but presumed reasonable specificity for clinical deterioration

A number of explanations have been suggested for the low sensitivity of guideline weight gain including the use of an absolute threshold for weight gain (i.e. 2 kg regardless of baseline body weight). In addressing this issue, however, Lewin et al. showed that simply accounting for differences in individual body weight, by expressing the weight gain as a % of body weight, over the 2-3 day time period doubles the sensitivity of the test from 9% to 17%. However, this approach remains specific but insensitive as a screen for deterioration.

An explanation for the insensitivity of current methods is the fact that in many cases, the deterioration (and therefore the associated weight gain) is much more gradual, beginning more than 1 week before the final decompensation and hospitalisation occurs (Patterns of Weight Change Preceding Hospitalization for Heart Failure”, Chaudhry et al., Circulation, Oct. 2, 2007, 1549-1554 [doi:10.1161/circulationaha.107.690768]).

Another shortcoming with the application of the Guideline criteria (i.e. the criteria laid down in the Guidelines published by the European Society of Cardiology and American College of Cardiology/American Heart Association) is that there is an assumption that the underlying stable weight does not dramatically change. Finally, the implementation of Guidelines using manual patient monitoring assumed compliance with the weight monitoring, an ability of patients to read the scales and patient understanding of the changes associated with deterioration.

Other research groups have looked at weight gain over longer periods of time and have found this to be more sensitive (“A New Monitoring Method for the Estimation of Body Fluid Status by Digital Weight Scale Incorporating Bioelectrical Impedance Analyzer in Definite Heart Failure Patients”, Kataoka, J Cardiac Fail 2009; 15:410-418 [doi:10.1016/j.cardfail.2008.12.008]). However, there are difficulties in knowing the true stable weight in populations over protracted periods of time. This is particularly try in patients who might be overweight and encouraged to lose weight, or might be cachectic, as frequently occurs in heart failure.

A further complicating factor here is the variability around weight measurements which can be considerable and exceed the “2 kg” guideline threshold on a daily basis (“Daily variability in dyspnea, edema, and body weight in heart failure patients”, Webel et al., European Journal of Cardiovascular Nursing 6 (2007), 60-65 [doi:10.10161j.ejcnurse.2006.04.003]).

In summary, while weight gain is advocated by European and American guidelines, there are relatively few published data on this area. The current guidelines are insensitive (i.e. the majority of decompensations do not fit the guideline). An alternative approach, which characterises the patient as having a fixed stable weight, is more sensitive, less specific and incorrectly assumes that patients neither gain nor lose dry weight. However, we know that there is considerable variability in some weight changes on a daily basis resulting in too many “false positives” and poor specificity for some people. For some patients, therefore, the daily weight fluctuations can be over-interpreted resulting in loss of confidence in weight monitoring by patients and carers.

### DISCLOSURE OF THE INVENTION

There is provided a method of evaluating a subject's weight comprising the steps of:
(a) maintaining a record containing a historical set of indications of the weight of the subject;
(b) receiving a new indication of the weight of the subject;
(c) adding the new indication to the record;
(d) calculating a moving average of the weight of the subject based at least on a plurality of indications in the record immediately preceding the new indication;
(e) comparing the new indication with the calculated moving average;
(f) generating a first form of alert if the new indication differs from the calculated moving average by more than a threshold amount;
(g) iteratively repeating steps (b) to (f) for subsequently received new indications and, if said first alert is generated consecutively on a predetermined number of successive iterations, generating a second form of alert different from the first form of alert.

There is also provided a computer-implemented method of evaluating a subject's weight, comprising the following steps carried out in a computer system:
(a) maintaining a record containing a historical set of indications of the weight of the subject;
(b) receiving as an input to the computer system a new indication of the weight of the subject;
(c) adding the new indication to the record;
(d) calculating, using a processor of the computer system, a moving average of the weight of the subject based at least on a plurality of indications in the record immediately preceding the new indication;
(e) comparing the new indication with the calculated moving average;
(f) generating at an output of the computer system a first form of alert if the new indication differs from the calculated moving average by more than a threshold amount;
(g) iteratively repeating steps (b) to (f) for subsequently received new indications and, if said first alert is generated consecutively on a predetermined number of successive iterations, generating at an output of the computer system a second form of alert different from the first form of alert.

The method is preferably implemented by programming a genera purpose computer system to provide a machine which is particularly adapted to carry out the method.

Another aspect of the invention provides a computer program product comprising a tangible data carrier encoding the program instructions of the computer-implemented method. Such a data carrier typically comprises an optical or magnetic data carrier, a memory chip, a flash drive, a hard drive, etc.

There is further provided a system for evaluating a subject's weight, comprising:
(a) a record containing a historical set of indications of the weight of the subject;
(b) an input for receiving a new indication of the weight of the subject;
(c) an updating mechanism for adding the new indication to the record;
(d) a processor programmed to:
   (i) calculate a moving average of the weight of the subject based at least on a plurality of indications in the record immediately preceding the new indication;
   (ii) compare the new indication with the calculated moving average; and
   (iii) generate a first form of alert if the new indication differs from the calculated moving average by more than a threshold amount;
   (iv) iteratively repeat steps (i) to (iii) for subsequently received new indications and, if said first alert is generated consecutively on a predetermined number of successive iterations, to generate a second form of alert different from the first form of alert;
(e) one or more outputs for communicating said first and second alerts.

The preferred features defined below are to be understood as applying equally to all aspects of the invention including the method, the computer-implemented method, the computer program product, the system, and so forth.

Unlike prior art methods of evaluating weight, which look for a specified increase in weight over a fixed period, the method and system of the invention look for an increase in weight relative to a threshold above a moving average calculated from a set of previously collected weight measurements. In this way, gradual variations in weight can be catered for. The method is no longer underpinned by the assumption that there is such a thing as a stable baseline weight for a patient. Furthermore, the method and system employ a staged alert mechanism which firstly notes a specified increase in weight and then monitors to see if this is repeated on subsequent measurements. If the alert is repeated on consecutive measurements, then an escalated alert is issued.

It has been surprisingly found that this method provides greater sensitivity and accuracy of alerts relative to the published guideline methods.

The literature shows that the guidelines issued by the American Heart Association and the European Society of Cardiology have unacceptably low sensitivity, i.e. relevant events which are indicative of a deterioration in the subject's condition are missed using these guidelines. It is hypothesised that the method of the invention is more successful because it is formulated to identify gradual fluid retention which is not manifested as a sudden weight increase.

Furthermore, the method provides automatic, dynamic individualization of the upper limit of normal weight using deviations from patient moving averages to generate system responses. This allows patients to gain or lose dry weight gradually without having to reset the thresholds for healthcare response.

The method can be combined with other recorded information about the patient, e.g. information from bio-sensors, bio-markers, clinical measurements, etc., which can be incorporated into the computer record for the patient.

The method can be combined with patient reported outcomes which can include one or more questions answered by the patient. Certain responses to those questions can trigger alerts regardless of changes in patient weight, or such responses can be used to vary parameters such as the threshold(s) at which alerts are to issue, e.g. by lowering a threshold for an alert to issue if a patient reports e.g. disturbed sleep.

Preferably, the method is carried out at a first location which is remote from the location at which the subject's weight is measured. Thus, the weight measurements are preferably communicated from the subject's home location to a monitoring centre. Communication can be made using any suitable technology such as by telephone, over the internet, by wireless or radio signal, and so on.

Preferably, the calculation of the moving average is a simple moving average calculation.

Preferably, the inputted weights are taken on consecutive days, with the moving average providing a measure of the average weight of the subject over a predetermined number of days. Further, preferably, the weight measurements are taken at the same time of day on consecutive days.

The moving average is preferable calculated as the moving average based on the previous 7 or more measurements, more preferably on the previous 14 measurements.

Preferably, the threshold amount is calculated as a statistical metric indicative of the distribution of a plurality of indications in the record.

The statistical metric may, for example, be based on a measure of variance, standard deviation, probability distribution, or interval estimation such as confidence interval or Bayesian interval.

It is preferred, but not essential that the plurality of indications in the record employed to calculate said statistical metric is the same plurality of indications on which the moving average calculation is based.

Preferably, the threshold amount is calculated as a predetermined multiple of the standard deviation of the set of measurements from which the moving average is calculated.

Preferably, the threshold is one standard deviation.

Further, preferably, if the new indication differs from the calculated moving average by more than an elevated threshold amount, the second form of alert is generated instead of the first form of alert.

Preferably, the elevated threshold amount is 1.5 times the standard deviation.

The method further preferably comprises issuing a third form of alert if the second form of alert is repeated on a predetermined number of successive iterations.

Thus, the alert system can include a first form of alert (e.g. yellow alert), a second form of alert (e.g. orange alert) and a third form of alert (e.g. red alert), with the orange alert being issued if the yellow alert condition is met on, for example, two or three consecutive days. If, on the next day, the threshold condition for the yellow alert is again met, then the orange alert is maintained and reissued. Generating the orange alert in this way on e.g. two or three consecutive days causes the red alert to be generated.

As indicated previously, if the threshold condition for a yellow alert is, for instance, a weight gain of at least 1 standard deviation over the moving average, and if the elevated threshold condition for an orange alert is, for instance, a weight gain of at least 1.5 standard deviations over the moving average, then the system can generate an orange alert without first having generated a yellow alert. If, on the next day's measurement, the new weight measurement is between 1 and 1.5 standard deviations above the moving average (which would normally cause a yellow alert to be generated), then it is preferred that the system maintains the orange alert rather than de-escalating to a yellow alert. Repeating the orange alert in this way on consecutive iterations (i.e. due to repeated measurements in breach of the yellow alert criterion) will then cause the red alert to be generated.

Further preferably, there is a further elevated threshold which, if breached, causes the third form of alert to issue immediately without escalating through the first and second forms of alert.

Thus, for example, it is currently preferred to issue the red alert if the new indication is more than 2 standard deviations above the moving average. The system can also take account of the known absolute weight gain methods by triggering an orange or a red alert if the new indication meets the known guideline criteria, e.g. any 2 kg or 2% increase in 2 days or 3 days.

Preferably, the number of consecutive instances of the first form of alert required to generate the second form of alert is 2 or 3. Similarly, the number of consecutive instances of the second form of alert required to generate the third form of alert is preferably 2 or 3.

The threshold, elevated threshold, or further elevated threshold can be predetermined using other measures apart from a measure of standard deviation. For example, in an alternative embodiment, a threshold is calculated as being a limit of a confidence interval for the data set used to generate the moving average. Preferably, the threshold is an upper limit of a confidence interval greater than 90%. Any such confidence limit may be used, such as for example 95%, 99% or 99.9%, although the invention is not limited to these specific thresholds.

Preferably the calculation of moving average includes not only the plurality of indications in the record immediately preceding the new indication, but also the new indication itself.

If data are missing for any time period (e.g. there are gaps in the record due to a system failure or due to human failure or error to report or input a weight measurement), then the moving average may either be calculated on the same number of preceding measurements, such as the last 14 measurements, or it may be based on however many preceding measurements are stored for a given time period, e.g. by using the 12 recorded measurements added to the system over the last 14 day period, if 2 measurements are missing from that 14 day period. As a further alternative, missing readings can be interpolated between the immediately preceding and succeeding measurements.

Further, preferably, the data is checked to avoid duplication of indications (e.g. two measurements with a time stamp indicating that the readings relate to the same day) and to validate the data (e.g. by ensuring that the measurement is within the correct approximate range. The data may also be validated in other ways, such as by ensuring that a timestamp relates to a morning reading. Where missing or unsatisfactory data are detected, interpolation may be used to construct an appropriate reading or the data may simply be ignored for the relevant period.

Preferably, the first, second or third form of alert triggers an automated communication system to initiate a communication to the subject, e.g. by a telephone switch with a recorded message system, or by an email or web alert.

Alternatively or additionally, the first, second or third form of alert may trigger an automated communication to be sent to an emergency dispatching system, or to a healthcare professional responsible for the care of the subject.

There is also provided a method of evaluating a subject's weight comprising the steps of:
(a) maintaining a record containing a historical set of indications of the weight of the subject;
(b) receiving a new indication of the weight of the subject;
(c) adding the new indication to the record;
(d) calculating a moving average of the weight of the subject based at least on a plurality of indications in the record immediately preceding the new indication;
(e) comparing the new indication with the calculated moving average;
(f) generating a first form of alert if the new indication differs from the calculated moving average by more than a first threshold amount;
(g) generating a second form of alert different from the first form of alert if the new indication differs from the calculated moving average by more than a second threshold amount, the second threshold amount being greater than the first threshold amount; and
(h) iteratively repeating steps (b) to (g) for subsequently received new indications and, if said first alert is generated consecutively on a predetermined number of successive iterations, generating said second form of alert, even if the new indication does not differ from the calculated moving average by more than said second threshold amount.

Thus, this alternative method provides for first and second forms of alert, with the second form being of a higher priority than the first form. The alert generated by any given new indication can be escalated from the first form to the second form either by a higher threshold being breached or by a lower threshold being repeatedly breached. There may be, and preferably there will be, third, fourth or higher forms of alert also, and in general the system will evaluate the condition for each form of alert individually, i.e. checking whether a new indication meets each different criterion for an individual alert, as well as evaluating whether a lower form of alert, being maintained over successive iterations, is to be escalated to a higher form of alert. Having made these evaluations and possibly having generated as a result, several forms of alert, the highest alert is communicated.

In a preferred method, the following responses occur to the three preferred forms of alert (or “flag”):
Any yellow flag=monitor closely
Any orange flag=clinic initiated phone call or automated initiation of a telephone call back
Any red flag=medical intervention (automated initiation of a telephone call back) with remote increase in diuretic with GP follow up, or clinic visit.

The method preferably includes a recruitment monitoring period, during which the system is manually managed by clinical staff while the system “learns” the patient weight pattern. For the initial monitoring period (14 days generally), reliance on guideline intervention and transtelephonic contact with patient will be necessary. If the patient does not stabilize in the initial recruitment monitoring period, this period must be extended.

In a preferred embodiment the monitoring will involve 4 simultaneous “streams” of upper limit of normal monitoring with appropriate staged warning “flags” (see above). This is designed to capture gradual and acute decompensations unlike conventional systems and guidelines:
i) Daily weight >1 SD above 14d MAF=yellow flag. On the third day of consecutive yellow flags, this switches to an orange flag. On the third day of consecutive orange flags, this turns to a red flag
ii) Daily weight >1.5 SD above 14d MAF=orange flag. On the third day of consecutive orange flags, this turns to a red flag
iii) Daily weight >2 SD above the 14d MAF=red flag
iv) Any 2 kg increase in 2 days or 3 days=red flag (guideline)

These alternatives are designed to capture both rapid and gradual deterioration as well as to capture published guideline criteria in order to provide for clinical indemnity cover.

As well as system automatic adjustment of sensitivity using moving average-based upper limits of normal ranges, there may also be clinician directed manual adjustable sensitivity (“tuning system to patient”). This can be done by altering 3 variables:
1. Increased moving average time for moving average indicators (MAIs), e.g. 14 day vs. 7 day, will increase sensitivity. It is currently suggested that this is the primary mechanism by which system sensitivity is adjusted.
2. Reduced number of consecutive days before moving to next flag level (i.e. yellow to orange) will increase sensitivity (e.g. 2 vs. 3 days).
3. Decreased standard deviation multiple (or adjustment of confidence intervals) increases sensitivity.

### Recruitment and System Initiation:

On recruitment to the system, each patient is initiated with 14 day MAIs for maximal sensitivity, attenuated by a 3 consecutive day requirement before moving on to the next warning flag level and the upper limit of acceptable weight monitoring streams will be set at [1] published AHA/ESC guidelines and [2-4] MAI plus 1 SD, 1.5SD and 2 SD respectively. If adjusting the MAI time to alter sensitivity, consider attenuating this by adjustments in the SD multiple or the number of consecutive days before transition to next level warning flag.

Initial characterization of patient can be as [1] high or [2] low risk. If high risk, the system is set ab initio at highest sensitivity setting. If the patient is high risk, then the system will continually warn against reduction in the system sensitivity. Exemplary (and non-limiting) reasons and indicators for a high risk patient might include:
Elevated stable levels of Brain natriuretic peptide/B-type natriuretic peptide (BNP), e.g. >250 pg/mL and/or failure to reduce BNP >30% within 2 weeks of discharge
Recent (<3 months) clinical deterioration (e.g. IV diuretic or admission)
Renal dysfunction (e.g. creatinine >200 mmoL)
Compliance concerns (e.g. Morisky Adherence Score <4)

The system is preferably set to manage missing results (e.g. for one missing day, average day before and day after). If data is missing, the patient can be prompted automatically from phone software. For two missing days, an automatic orange flag may be set to check on patient compliance. This can be adjusted to patient type and/or lifestyle.

The system is preferably set up to perform data verification, i.e. it can discount impossible/inappropriate data—e.g. a child or heavier adult standing on the scales. In such a case, the software may prompt for correct data automatically by phone.

### BRIEF DESCRIPTION OF THE DRAWINGS

The invention will now be further illustrated by the following description of embodiments thereof, given by way of example only with reference to the accompanying drawings, in which:

FIG. 1 is a schematic architecture showing a system for evaluating a subject's weight;

FIG. 2 is a flowchart illustrating the operation of a method of evaluating a subject's weight;

FIG. 3 is a flowchart showing a continuation of the method of FIG. 2;

FIG. 4 is a flowchart showing a continuation of the method of FIG. 2;

FIG. 5 is a chart showing the comparative sensitivities of three approaches to weight monitoring;

FIG. 6 is a plot of a patient's weight in the period before, during and after a clinical deterioration, showing the points at which alerts are generated; and

FIGS. 7A-7C are plots of patient weights showing variations not associated with clinical deteriorations due to heart failure.

### DETAILED DESCRIPTION OF PREFERRED EMBODIMENTS

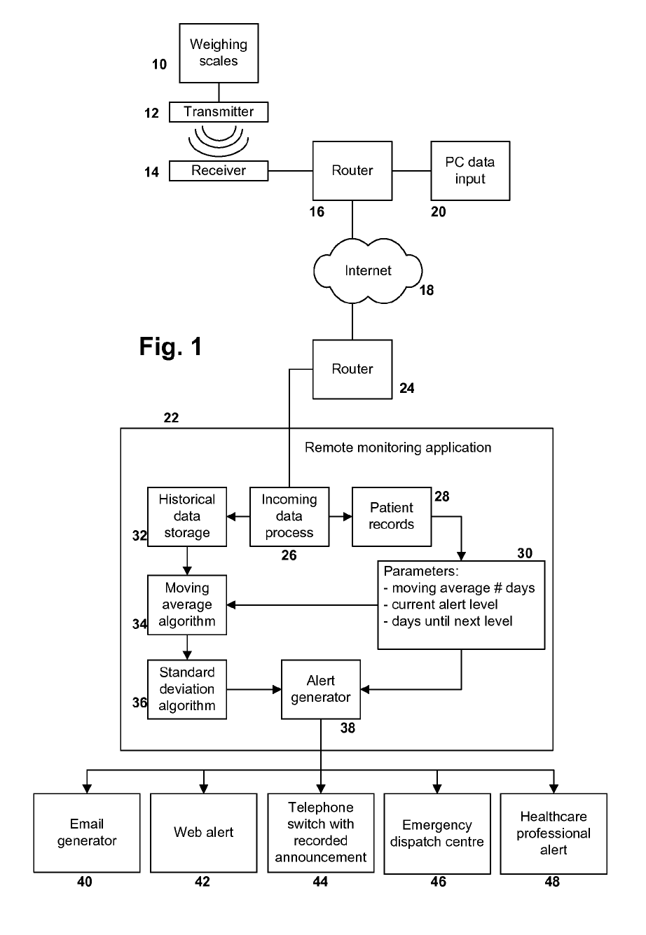

In FIG. 1 there is shown a system in which a subject's weight is measured e.g. at home using a weighing scales 10. The scales 10 may be wirelessly enabled via a transmitter 12 and receiver 14 to automatically send data to a router 16 providing a connection to the internet 18. Alternatively, the user may use a conventional weighing scales and enter the weight reading into a personal computer 20 or other communication device connected to the internet 18. Data can of course also be communicated verbally, by telephone, or in any other suitable way.

The data, in the form of a weight reading, is sent to a monitoring application 22 which is normally remote from the subject, and is typically a piece of software operating on any suitable computer system or processor. In the illustrated embodiment, the remote monitoring application is on a computer system connected by a router 24 to the internet 18.

Data is received by an incoming data process 26 which validates and correlates the data against a set of patient records 28, to determine and validate the identity of the subject and to trigger the patient records to populate a parameter storage area 30 with parameters to be used in evaluating the patient's weight, such as the number of days over which the moving average must be calculated, a current alert level showing the level of the alert (if any) calculated on the previous iteration, and the number of days until the alert level is escalated (or alternatively, the number of consecutive days on which the current alert level has been generated, from which a decision can be made whether the next such alert should be escalated).

The incoming data process also writes the new weight data to a historical data storage area 32, i.e. a record of the data collected for the subject on each occasion. The data storage area maintains, for each subject, a record of the date (and optionally, time) as well as the measured weight.

When a new data point is written to the data storage area, this triggers a moving average algorithm 34 to be run by the processor, based on the parameters recorded in the parameter storage area 30. For example, for a given patient the parameter storage area may indicate that a 7 day moving average is to be used, in which case the algorithm retrieves the new weight measurement along with the previous 6 measurements (assuming one measurement is recorded per day). These values are summed and divided by 7 to give the current value for the moving average. The data points are also provided to a standard deviation algorithm 36 which calculates the standard deviation (SD) within that data set.

An alert generator 38 uses the average and the standard deviation values, together with the stored parameters, to decide if an alert should be generated and if so, the level of alert, as will be described below. If an alert is to be generated, this can be provided to any one or more of a number of outputs, including: an email generator 40 which can send an email to the patient or a healthcare provider, for example; a web alert generator 42 which issues an alert to a web-based application over the internet 18, such as an application running on the users PC 20; a telephone switch with recorded announcement facility 44 which can initiate a telephone call on foot of the alert; a connection to an emergency dispatch centre 46 or other facility which can cause an ambulance to be sent to the patient's home or can be used as a trigger for a paramedic to call the patient; and a connection to a healthcare professional's system 48 which can alert the patient's doctor or nurse of the alert, allowing that professional to make a decision as to the next action to take based on the nature of the alert.

The alert generator may evaluate the new indication using several parallel evaluations, each being indicative that a different alert is to be generated, and then ultimately provide at an output a single alert which is indicative of the highest indicated form of alert, as will be described further below.

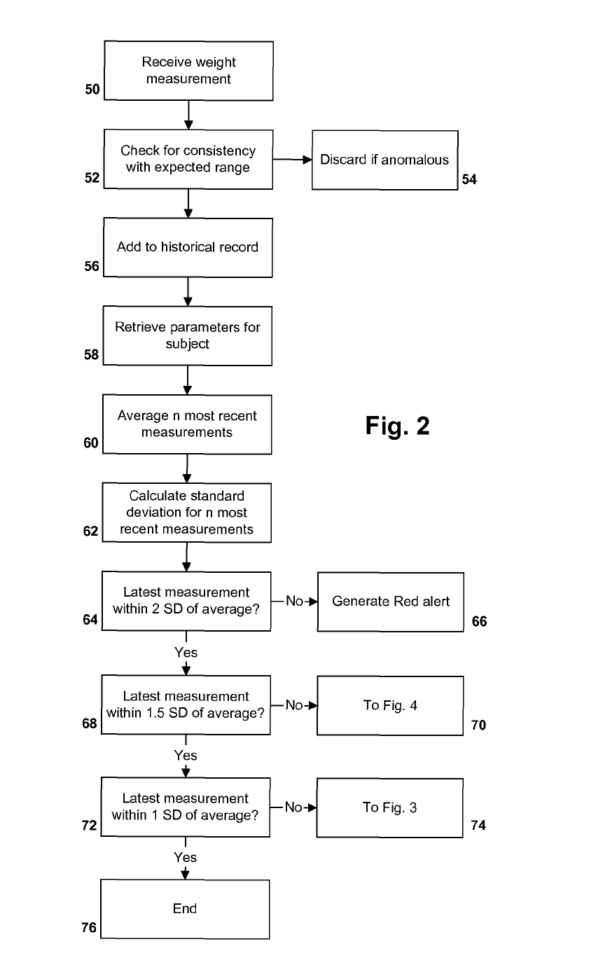

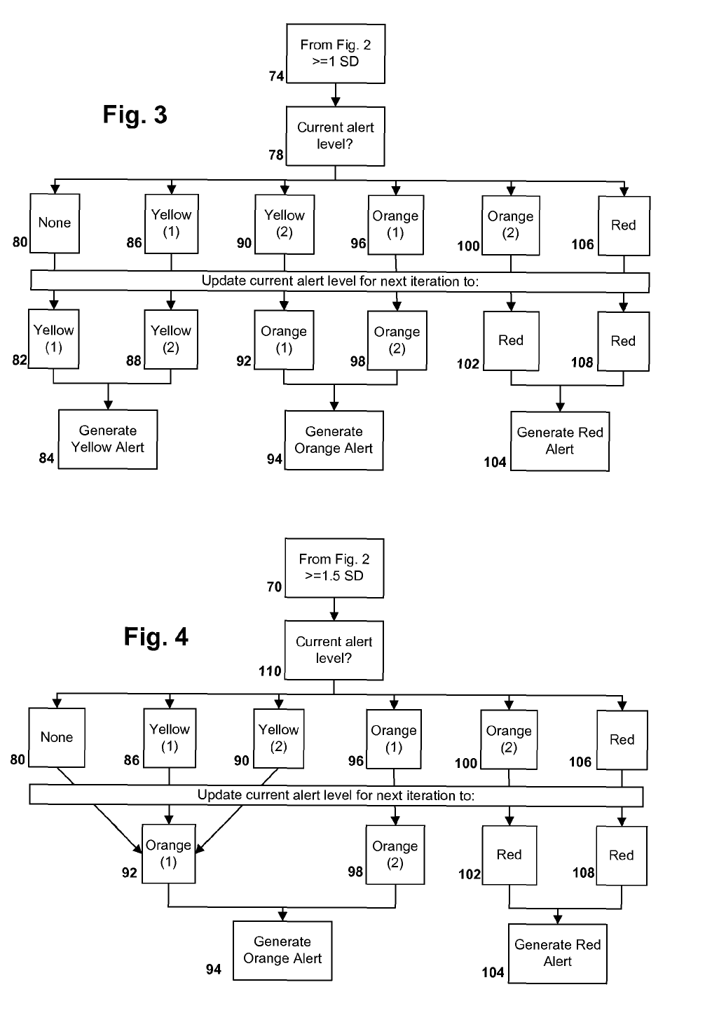

FIG. 2 shows a flowchart of the method used by the monitoring application 22. In step 50, a weight measurement is received. An initial consistency check is made, step 52, to ensure that the weight is within an expected range, to eliminate clearly spurious data. The data is also evaluated to ensure that it is not a duplicate data point for approximately the same time range, in which case it may either be discarded or an average of multiple such data points can be stored. If the data is determined to be spurious, it is discarded, step 54. If this happens the system may optionally (not shown) trigger a telephone call to the user seeking corrected data.

If data is received and not spurious, it is added to the historical data record for that particular patient, step 56. Identification of the correct patient can be made by information contained in the data itself, such as an ID number received from the weighing scales when it transmits its data, or from information keyed in by the user into the PC when entering weight data, or manually added by, for example, a telephone operator at the health facility after speaking with the patient.

Then the parameters for the patient are retrieved, step 58, for example the current alert level for that patient, the number of days on which the patient has been at that alert level, and the number of days being used for the moving average calculation.

In this system being described, the data is evaluated against three different thresholds (each being a moving average plus a different multiple of the standard deviation of the data set used to calculate that moving average), and the “current alert level” record in fact maintains three such indicators, each being indicative of the degree to which the alert has been escalated according to the number of consecutive instances where each threshold has been breached. Thus, a current alert level for the data evaluation against the “yellow” criteria may indicate that this alert has been repeated five times in a row, so that the most recent alert status according to that stream of evaluation has been escalated from yellow through orange (on day three) to red (on day five). Simultaneously, a current alert level for the data evaluation against both the “orange” and “red” criteria may indicate no alert, e.g. if the most recent reading breached the “yellow” threshold but was below both the “orange” and “red” thresholds.

The required number of days of data beginning with the most recently added measurement and working backwards e.g. 7, 10 or 14 days, are retrieved from the historical record and averaged, step 60. This latest value for the moving average is typically recorded both in short-term memory and in the historical record for the patient.

In step 62, the standard deviation is calculated from the data set used to calculate the moving average. Standard deviation is calculated based on the value of the difference between each data point and the calculated average. These values are squared, and the sum of the squares is divided by the number of values. Finally the square root of this calculation is the standard deviation. The standard deviation (SD) is stored both in short-term memory and in the historical data record.

An alternative to a standard deviation calculation may be, for instance, a calculator which calculates the 95%, 99% or 99.9% confidence interval for any desired set of previous readings, such as for the set of readings used to generate the moving average.

In step 64, the difference between the latest measurement and the moving average value is calculated, and if this difference, D, is greater than or equal to twice the standard deviation, 2*SD, then a red alert (third form of alert) is automatically generated in step 66. This alert is generated regardless of the previous alert history. Note that the calculation only looks at the difference if the new value is higher than the average, not if it is lower than the average, i.e. it is only concerned in this case with weight increases.

In a preferred method, the decision to generate a red alert in step 66 does not prevent the algorithm from also evaluating what alert will be generated using other criteria. While one can expect that a weight increase which exceeds the “red” threshold will also exceed both the “orange” and “yellow” thresholds, the purpose of following through on these calculations is that the system maintains for each of the criteria a separate “current alert” record, and consistent breaches of the “yellow” or “orange” thresholds continue to be recorded so that the escalation of alert arising from those persistent breaches is maintained even if the next reading drops below the “red” threshold.

FIG. 2 does not show a check being made against other criteria such as the check for an absolute weight increase of 2% or 2 kg over a 2-3 day period, but it is to be understood that such checks may also be made and that such checks, if positive, will typically also result in the immediate generation of a red alert.

If the difference is less than 2*SD, the process then checks if the standard deviation is greater than 1.5*SD, step 68. If so, the process moves in step 70 to FIG. 4 as will be described further below. Basically, this determination of D>=1.5*SD means that the system will issue an orange alert at the minimum, and possibly a red alert if it has occurred on several consecutive days, and the process of FIG. 4 checks to see whether an orange or red alert should issue.

As discussed above, in a preferred embodiment, even if the determination in step 64 is negative, i.e. the measurement is at least two standard deviations above the moving average, the red alert is indicated to be generated in step 66, but the process then also (not shown) reverts to step 68 to complete the evaluation against the 1.5 SD criterion.

If the determination in step 68 is negative, then a check is made to see if D>=1*SD, step 72. Again, even if the determination in step 68 is positive, the process will proceed to step 68 in parallel with completing the process of FIG. 4 or sequentially.

If the determination in step 72 shows that the difference is greater than or equal to one standard deviation, then this is indicative of at least a yellow alert, and possibly an orange or even red alert depending on the previous alert history, and this is determined when the process moves in step 74 to FIG. 3.

If none of the alert conditions are met in steps 64,68 or 72, then the current iteration of the process ends, step 74. The process will of course be repeated on subsequent days (assuming daily measurements) or at whatever time intervals or measurement intervals have been set. By having a scheduled iteration (e.g. daily, even if no indication has been received by a cut-off time) the system can prompt the user or doctor for the fact that there is no current day's indication to use in its calculation, and can trigger an appropriate alert if the patient is at high risk or is already in breach of an alert condition.

FIG. 3 shows the continuation of the process from step 74, i.e. where D>=1*SD. In step 78 the current alert level, i.e. the level of alert, if any, generated on the previous iteration, which is stored in the patient parameter records.

If there was no alert on the previous day, step 80, then the current alert level is recorded for this iteration as being yellow (1), i.e. the first occurrence (in the present cycle) of a yellow alert, step 82. Then the system generates the yellow alert, step 84, in accordance with the rules set up for such an alert, which may be for example, a note being written to the patient's file, or a telephone alert being sent to the patient.

If the current alert level recorded on the previous iteration is yellow (1), step 86, then this is updated to yellow (2), indicating that this is the second consecutive yellow alert to issue for this patient, step 88, following which a yellow alert is generated, step 84.

If the current alert level is yellow (2), step 90, then according to the parameters for the illustrated patient, this means that an orange alert must be generated, i.e. on the third consecutive day of weight increase greater than one standard deviation, the alert is elevated from yellow to orange. Accordingly the current alert level indicator is updated to orange, step 92, and an orange alert is generated accordingly, step 94.

If an orange alert has already issued once, i.e. the current alert level is orange (1), step 96, then this is updated to orange (2), step 98, and an orange alert is generated, step 94.

In similar manner, if the current alert level is determined to be orange (2), step 100, then the alert is elevated to red, causing the current alert level to be updated accordingly, step 102, and a red alert to issue, step 104. If the current alert level is red, step 106, then this is maintained, step 108 and a red alert is generated again, step 102. Generally, in the illustrated system, the red alert is the highest level of alert and will cause medical intervention to ensue for further evaluation and treatment (if necessary) of the patient.

FIG. 4 shows a continuation of the process, similar to that of FIG. 3, but applicable when the difference in weight over the moving average is greater than 1.5 standard deviations, step 70. In such cases, the question to be determined is whether this should result in an orange alert or a red alert. Accordingly in step 110 the current alert level record is checked to see what level of alert was most recently issued to the patient.

Using the same reference numerals for the current alert level as in FIG. 3, if the current alert level is none, yellow (1) or yellow (2), as seen in steps 80,86,90, the current alert level is updated to orange (1), step 92 and an orange alert is issued, step 92.

In all other cases, i.e. where the current alert level is orange (1), orange (2), or red, as seen in steps 96,100,106, the process proceeds exactly as in FIG. 3, i.e. with the current alert level being elevated one level and an orange or red alert issuing as appropriate.

An example of a set of real patient weight measurements, together with a number of different analyses of these data according both to the invention and to conventional guideline criteria will now be provided.

TABLE 1
Daily weight (kg)

| Day | Ref | Weight |
|---|---|---|
| −14 | training | 77.8 |
| −13 | training | 77.8 |
| . . . | training | . . . |
| −2 | training | 79.0 |
| −1 | training | 79.1 |
| 0 | training | 78.9 |
| 1 | 20090527080828 | 77.8 |
| 2 | 20090528064140 | 78.3 |
| 3 | 20090529072806 | 78.0 |
| 4 | 20090530095032 | 78.4 |
| 5 | 20090531074811 | 78.9 |
| 6 | 20090601074719 | 78.6 |
| 7 | 20090602064102 | 78.3 |
| 8 | 20090603075314 | 78.3 |
| 9 | 20090604070824 | 78.3 |
| 10 | 20090605075142 | 79.1 |
| 11 | 20090606054144 | 79.1 |
| 12 | 20090607062529 | 78.9 |
| 13 | 20090608055556 | 78.9 |
| 14 | 20090609071521 | 78.5 |
| 15 | 20090610080822 | 78.9 |
| 16 | 20090611081610 | 79.3 |
| 17 | 20090612061549 | 79.2 |
| 18* | 20090613054040 | 79.6 |
| 19* | Missing | 80.0 |
| 20* | 20090615071226 | 80.3 |
| 21* | 20090616072932 | 80.0 |
| 22* | 20090617063204 | 81.0 |
| 23* | 20090618073119 | 80.4 |
| 24* | 20090619065535 | 80.9 |
| 25* | 20090620083222 | 81.4 |
| 26* | 20090621063102 | 81.8 |
| 27* | 20090622072259 | 82.0 |
| 28 | 20090623052508 | 80.8 |
| 29 | 20090624055744 | 78.5 |
| 30 | 20090625080926 | 77.9 |
| 31 | 20090626073804 | 77.5 |
| 32 | 20090627073328 | 78.2 |
| 33 | 20090628065835 | 78.7 |
| 34 | 20090629072225 | 78.8 |
| 35 | 20090630055855 | 79.8 |
| 36 | 20090701070529 | 79.3 |
| 37 | 20090702074635 | 78.7 |
| 38 | 20090703073110 | 79.5 |
| 39 | 20090704071528 | 79.7 |
| 40 | 20090705070456 | 79.4 |
| 41 | 20090706074030 | 79.0 |
| 42 | 20090707072121 | 78.2 |
| 43 | 20090708061704 | 78.4 |
| 44* | 20090709064436 | 79.4 |
| 45* | 20090710064950 | 81.1 |

TABLE 2
Gain over 1-3 days

| 1 day gain | 2 day gain | 3 day gain |
|---|---|---|
| −1.1 | −1.3 | −1.2 |
| 0.5 | −0.6 | −0.8 |
| −0.3 | 0.2 | −0.9 |
| 0.4 | 0.1 | 0.6 |
| 0.5 | 0.9 | 0.6 |
| −0.3 | 0.2 | 0.6 |
| −0.3 | −0.6 | −0.1 |
| 0.0 | −0.3 | −0.6 |
| 0.0 | 0.0 | −0.3 |
| 0.8 | 0.8 | 0.8 |
| 0.0 | 0.8 | 0.8 |
| −0.2 | −0.2 | 0.6 |
| 0.0 | −0.2 | −0.2 |
| −0.4 | −0.4 | −0.6 |
| 0.4 | 0.0 | 0.0 |
| 0.4 | 0.8 | 0.4 |
| −0.1 | 0.3 | 0.7 |
| 0.4 | 0.3 | 0.7 |
| 0.3 | 0.7 | 0.6 |
| 0.4 | 0.7 | 1.1 |
| −0.3 | 0.1 | 0.4 |
| 1.0 | 0.7 | 1.1 |
| −0.6 | 0.4 | 0.1 |
| 0.5 | −0.1 | 0.9 |
| 0.5 | 1.0 | 0.4 |
| 0.4 | 0.9 | 1.4 |
| 0.2 | 0.6 | 1.1 |
| −1.2 | −1.0 | −0.6 |
| −2.3 | −3.5 | −3.3 |
| −0.6 | −2.9 | −4.1 |
| −0.4 | −1.0 | −3.3 |
| 0.7 | 0.3 | −0.3 |
| 0.5 | 1.2 | 0.8 |
| 0.1 | 0.6 | 1.3 |
| 1.0 | 1.1 | 1.6 |
| −0.5 | 0.5 | 0.6 |
| −0.6 | −1.1 | −0.1 |
| 0.8 | 0.2 | −0.3 |
| 0.2 | 1.0 | 0.4 |
| −0.3 | −0.1 | 0.7 |
| −0.4 | −0.7 | −0.5 |
| −0.8 | −1.2 | −1.5 |
| 0.2 | −0.6 | −1.0 |
| 1.0 | 1.2 | 0.4 |
| 1.7 | 2.7 | 2.9 |

TABLE 3
Comparison with guidelines

| >1.4 kg in | >2 kg in | >2.2 kg in |
|---|---|---|
| 1 day? | 2 days? | 3 days? |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| — | — | — |
| Y E S | Y E S | Y E S |

Table 1 shows the actual patient-submitted weight readings for a patient who suffered two clinical deteriorations during the period being monitored.

Weight readings were taken daily by the patient and communicated to his doctor. In order to enable a moving average to be calculated, and in order to evaluate the stability of the patient, a recruitment period of 15 days was completed during which the patient submitted daily weight readings which were recorded but not evaluated using the algorithms of the invention. The recruitment period measurements are not shown in full but run from day—14 to day 0 (with the evaluation proper starting on day 1, immediately following day 0).

The first column in Table 1 shows the day number. (The convention used herein is to refer to the columns in each table as first, second, etc. (or column 1, 2, etc.) counting from the left-hand column towards the right-hand column.)

The second column in Table 1 headed “Ref” is a unique ID associated with each measurement. The IDs are in fact time stamps, and thus the ID Ref for day 1 (20090527080828) indicates a date and time stamp of 2009-05-27 (i.e. May 27, 2009) at 28 seconds after 8:08 am. Using these time stamps, one can readily detect duplicates. For example, in the actual data record for this patient, a subsequent reading, also indicating a weight of 77.8 kg was discarded because its time stamp of 20090527081252 showed it to have been taken and transmitted within under five minutes of the first reading, making it redundant.

Also, as seen at day 19, missing readings can be easily detected, particularly if the patient is evaluated daily using a daily algorithm. The patient failed to submit a reading on day 19, so the system interpolates between the day 18 and day 20 readings of 79.6 and 80.3 kg respectively, to arrive at a (rounded) figure of 80.0 kg for day 19. It is possible for a missing reading to trigger an alert, and it is up to the designers and operators of the system to decide the extent to which interpolation is to be used to fill in gaps in the record.

All readings are shown rounded to the nearest 0.1 kg, but the system may maintain weight measurements and may perform calculations to greater or lesser degrees of accuracy.

In Table 1, days 18-27 and 44-45 are highlighted with an asterisk because of two deteriorations suffered by the patient at these times, which were clinically manifested Between days 18 and 27 this patient deteriorated clinically in a gradual fashion and was treated using an outpatient hospital visit. A few weeks later, the same patient deteriorated rapidly and was hospitalised (days 44 and 45). At this stage, this patient was hospitalised (hence the lack of subsequent readings).

Such clinical deterioration, in patients with decompensated heart failure, is manifested with signs (e.g. weight gain, fast heart rate, reduced cardiac output, oedema etc) and symptoms (e.g. dyspnoea, orthopnoea), and when severe the condition requires hospitalisation and can ultimately cause death. Early intervention with therapies can prevent hospitalisation and death, and it is precisely in order to detect such signs of decompensation that the ESC and ACC guidelines are intended.

Table 2 shows for each day, the difference in weight relative to the previous day (1 day gain), relative to the reading from two days previously (2 day gain) and three days previously (3 day gain). Where the current weight is greater than the relevant previous reading, the figure in Table 2 is shown as a positive number, and where it shows a decrease in weight, the figure in Table 2 is a positive number. This convention is followed for all subsequent comparisons in the Tables which follow below.

So for example, looking at the entries in Table 2 corresponding to the reading for day 24, when a weight measurement of 80.9 kg was recorded, we see that the 1 day weight gain is +0.5 kg, i.e. the day 24 weight of 80.9 kg is 0.5 kg greater than the day 23 weight of 80.4 kg. The 2 day weight gain is −0.1, i.e. the weight on day 24 is 0.1 kg less than on day 22 when it was 81.0 kg. And similarly, the 3 day weight gain shows that on day 24 the weight reading is 0.9 kg greater than on day 21, when it was 80.0 kg.

Table 3 then evaluates, for the 1 day, 2 day and 3 day weight gains of Table 2, whether these meet various published criteria such as a 3 lb (1.4 kg) overnight weight gain (first column of Table 3); an increase of 2 kg in 2 days (second column); or a 5 lb (2.2 kg) increase in 3 days. In each case it can be seen that the relevant published guideline criterion is met for the first time only on day 45. Each of these published criteria is, for the patient data of Table 1, not sufficiently sensitive to detect a decompensation event occurring on days 18-27.

Incidentally, while the second column of Table 3 shows the lack of any matches for the criterion of 2 kg weight gain over 2 days, the alternative (and lower) criterion of 2 kg over 3 days is not shown specifically in Table 3, but a cursory examination of the Table 2 differences, third column, shows that even if this lower threshold was used, the first flag would have been raised only on day 45.

Accordingly, it can be seen that for the patient whose data are shown in Table 1, the published guideline criteria do not detect relevant decompensation events, which is in line with the published reviews indicating a sensitivity of only 9%.

It is also pointed out that using alternative criteria of a 2% weight gain over 2 or 3 days also fails to catch the deterioration at days 18-27.

The data from Table 1 are now analysed in different ways, to calculate the moving average over a number of days, the standard deviation of the data for each moving average calculation, and various levels of confidence interval for each such data set.

TABLE 4
3 day moving average & associated
statistical measures, days 14-23

| | | 3 day | Standard | 95% confidence |
|---|---|---|---|---|
| Day | Weight | moving average | Deviation | interval |
| 14 | 78.5 | 78.8 | 0.2 | 79.0 |
| 15 | 78.9 | 78.8 | 0.2 | 79.0 |
| 16 | 79.3 | 78.9 | 0.4 | 79.4 |
| 17 | 79.2 | 79.1 | 0.2 | 79.4 |
| 18* | 79.6 | 79.4 | 0.2 | 79.6 |
| 19* | 80.0 | 79.6 | 0.4 | 80.0 |
| 20* | 80.3 | 80.0 | 0.3 | 80.3 |
| 21* | 80.0 | 80.1 | 0.2 | 80.3 |
| 22* | 81.0 | 80.4 | 0.5 | 81.0 |
| 23* | 80.4 | 80.5 | 0.5 | 81.0 |
| 24* | 80.9 | 80.8 | 0.3 | 81.1 |
| 25* | 81.4 | 80.9 | 0.5 | 81.5 |
| 26* | 81.8 | 81.4 | 0.5 | 81.9 |
| 27* | 82.0 | 81.7 | 0.3 | 82.1 |
| 28 | 80.8 | 81.5 | 0.6 | 82.3 |
| 29 | 78.5 | 80.4 | 1.8 | 82.4 |

In table 4, a three day moving average is calculated. This is a simple, unweighted moving average calculation, calculated each day using the three most recent weight measurements.

Thus for example, if one takes the moving average calculated on day 18, this figure of 79.4 (rounded) is calculated as the mean of the readings for days 16, 17 and 18 (data set: [79.3; 79.2; 79.6]). It is possible to substitute a weighted moving average for a simple moving average if desired. The standard deviation of the data set for those same days is 0.2, and the upper 95% confidence level for the same data set is 79.6.

Table 4 shows, for brevity, only a subset of the statistical metrics which may be calculated, and only shows the data for a limited period from days 14-29. This range is chosen to cover the period of the first decompensation event which required outpatient treatment. Obviously, the same techniques will in practice be applied every day and have been calculated for the entire period of days 1-45, although this is not shown.

Table 5 shows a similar set of statistical metrics, but calculated for a seven day, rather than a three day moving average data set (e.g. the data set used for the day 21 calculations are the weight measurements recorded on days 15-21 inclusive). Additionally, the final (rightmost) column in Table 5 supplements the statistical metrics with the 99% confidence level for each moving average calculation.

TABLE 5
7 day moving average & associated
statistical measures, days 14-23

| | | 7 day | | 95% | 99% |
|---|---|---|---|---|---|
| | | moving | Standard | confidence | Confidence |
| Day | Weight | average | Deviation | interval | interval |
| 14 | 78.5 | 78.7 | 0.4 | 79.0 | 79.1 |
| 15 | 78.9 | 78.8 | 0.3 | 79.0 | 79.1 |
| 16 | 79.3 | 79.0 | 0.3 | 79.1 | 79.2 |
| 17 | 79.2 | 79.0 | 0.3 | 79.2 | 79.2 |
| 18* | 79.6 | 79.0 | 0.4 | 79.3 | 79.4 |
| 19* | 80.0 | 79.2 | 0.5 | 79.6 | 79.7 |
| 20* | 80.3 | 79.4 | 0.6 | 79.8 | 80.0 |
| 21* | 80.0 | 79.6 | 0.5 | 80.0 | 80.1 |
| 22* | 81.0 | 79.9 | 0.6 | 80.4 | 80.5 |
| 23* | 80.4 | 80.1 | 0.6 | 80.5 | 80.6 |
| 24* | 80.9 | 80.3 | 0.5 | 80.7 | 80.8 |
| 25* | 81.4 | 80.6 | 0.5 | 81.0 | 81.1 |
| 26* | 81.8 | 80.8 | 0.6 | 81.3 | 81.5 |
| 27* | 82.0 | 81.1 | 0.7 | 81.6 | 81.8 |
| 28 | 80.8 | 81.2 | 0.6 | 81.6 | 81.7 |
| 29 | 78.5 | 80.8 | 1.2 | 81.7 | 82.0 |

Table 6 is similar to Table 5, but this time the moving averages are calculated over a 14 day period (e.g. the day 28 values are based on the set of measurements from day 15 to day 28 inclusive). The statistical metrics are further supplemented, relative to Tables 4 and 5, with a 99.97 confidence interval upper limit.

TABLE 6
14 day moving average & associated
statistical measures, days 14-23

| | | | Stan- | | | |
|---|---|---|---|---|---|---|
| | | 14 day | dard | 95% | 99% | 99.9% |
| | | moving | Devi- | confidence | Confidence | Confidence |
| Day | Weight | average | ation | interval | interval | interval |
| 14 | 78.5 | 78.5 | 0.4 | 78.7 | 78.8 | 78.9 |
| 15 | 78.9 | 78.6 | 0.4 | 78.8 | 78.9 | 78.9 |
| 16 | 79.3 | 78.7 | 0.4 | 78.9 | 78.9 | 79.0 |
| 17 | 79.2 | 78.8 | 0.4 | 79.0 | 79.0 | 79.1 |
| 18* | 79.6 | 78.9 | 0.4 | 79.1 | 79.1 | 79.2 |
| 19* | 80.0 | 78.9 | 0.5 | 79.2 | 79.3 | 79.4 |
| 20* | 80.3 | 79.0 | 0.6 | 79.4 | 79.5 | 79.6 |
| 21* | 80.0 | 79.2 | 0.6 | 79.5 | 79.6 | 79.7 |
| 22* | 81.0 | 79.4 | 0.7 | 79.7 | 79.9 | 80.0 |
| 23* | 80.4 | 79.5 | 0.7 | 79.9 | 80.0 | 80.1 |
| 24* | 80.9 | 79.6 | 0.8 | 80.1 | 80.2 | 80.3 |
| 25* | 81.4 | 79.8 | 0.9 | 80.3 | 80.4 | 80.6 |
| 26* | 81.8 | 80.0 | 1.0 | 80.5 | 80.7 | 80.9 |
| 27* | 82.0 | 80.2 | 1.1 | 80.8 | 81.0 | 81.2 |
| 28 | 80.8 | 80.4 | 1.0 | 80.9 | 81.1 | 81.2 |
| 29 | 78.5 | 80.4 | 1.0 | 80.9 | 81.1 | 81.3 |

Table 7 shows a first way in which the data from Tables 4-6 can be employed, with reference to the confidence intervals. For each day's reading (from days 14-29 which again is the period chosen for display), the current day's weight (i.e. the new indication received) is compared against carious confidence interval upper limits from Tables 4-6.

For example, the third column of Table 7 shows the difference between the weight in the second column, as measured for that day, and the 3 day 95% confidence interval upper limit (“3D 95% Cl”) which can be found in the final column of Table 4. Throughout the period from day 14 to day 29, the weight is consistently below this 3 day 95% confidence limit, suggesting that this comparison is not sensitive to a weight increase associated with the decompensation event which required treatment from day 18 onwards.

TABLE 7
Weight gain above or below upper confidence intervals
associated with moving averages, and associated flags
yellow (Y), orange (O) and red (R), days 14-23

| | | vs. | vs. | vs. | vs. | vs. | vs. |
|---|---|---|---|---|---|---|---|
| | | 3 D | 7 D | 7 D | 14 D | 14 D | 14 D |
| | | 95% | 95% | 99% | 95% | 99% | 99.9% |
| Day | Weight | CI | CI | CI | CI | CI | CI |
| 14 | 78.5 | −0.5 | −0.5 | −0.6 | −0.2 | −0.3 | −0.4 |
| 15 | 78.9 | −0.1 | −0.1 | −0.2 | +0.1 Y | +0.0 Y | −0.0 |
| 16 | 79.3 | −0.1 | +0.2 Y | +0.1 Y | +0.4 Y | +0.4 Y | +0.3 Y |
| 17 | 79.2 | −0.2 | +0.0 | −0.0 | +0.2 O | +0.2 O | +0.1 Y |
| 18* | 79.6 | −0.0 | +0.3 Y | +0.2 Y | +0.5 O | +0.5 O | +0.4 O |
| 19* | 80.0 | −0.1 | +0.4 Y | +0.3 Y | +0.8 R | +0.7 R | +0.6 O |
| 20* | 80.3 | −0.0 | +0.5 O | +0.3 O | +0.9 R | +0.8 R | +0.7 R |
| 21* | 80.0 | −0.3 | +0.0 | −0.1 | +0.5 R | +0.4 R | +0.3 R |
| 22* | 81.0 | −0.0 | +0.6 Y | +0.5 Y | +1.3 R | +1.1 R | +1.0 R |
| 23* | 80.4 | −0.6 | −0.1 | −0.2 | +0.5 R | +0.4 R | +0.3 R |
| 24* | 80.9 | −0.2 | +0.2 Y | +0.1 Y | +0.8 R | +0.7 R | +0.6 R |
| 25* | 81.4 | −0.1 | +0.4 Y | +0.3 Y | +1.1 R | +1.0 R | +0.8 R |
| 26* | 81.8 | −0.1 | +0.5 O | +0.3 O | +1.3 R | +1.1 R | +0.9 R |
| 27* | 82.0 | −0.1 | +0.4 O | +0.2 O | +1.2 R | +1.0 R | +0.8 R |
| 28 | 80.8 | −1.5 | −0.8 | −0.9 | −0.1 | −0.3 | −0.4 |
| 29 | 78.5 | −3.9 | −3.2 | −3.5 | −2.4 | −2.6 | −2.8 |

However, if one looks at the fourth column, comparing the day's weight with the 7 day moving average, upper limit of 95% confidence interval, it can be seen that on days 16, 18-20, 22, and 24-27, the weight exceeded the 7D 95% CI measurement taken from column 5 of Table 5.

Note that day 17 shows a difference of +0.0, suggesting that the difference, after rounding, is zero. In these examples, it has been decided to treat any figure rounded to zero as being zero, i.e. no alerts are generated in such cases. One could equally decide to ignore rounding and to strictly generate an alert for every non-negative comparison outcome, or indeed to vary the threshold so that an alert is generated if the difference is greater than any other threshold (such as the 95% confidence interval minus 0.1 kg, for instance).

On the days for which the column four comparison shows a positive difference, an alert is generated. On the first such instance after a day when the comparison was zero or less (i.e. days 16, 18, 22, 24) the alert is yellow, denoted by a “Y”. If the alert is repeated on the following day, it is again yellow (i.e. on days 19 and 25). When the confidence interval is exceeded on a third consecutive day (i.e. on days 20 and 26) the alert is escalated from yellow to orange. On a fourth consecutive day, the orange alert is again repeated (day 27). If the comparison for day 28 showed a further breach of the 7 day moving interval 95% confidence interval (which it does not) then the alert would have been further escalated from orange to red.

Day 21 shows that in the particular methodology chosen in column 4, an alert is immediately de-escalated as soon as a reading is received which is below threshold. Thus, the day 21 reading de-escalates from orange on day 20 to no alert (and a corresponding reset of all flags and alert counters) on day 21. It is possible for the de-escalation to be more gradual however, or for the system to defer from issuing any alert, but to gradually decrease the current alert counter which it maintains.

For example, with reference to FIGS. 3 and 4, the current alert level after the day 20 iteration would be at “Orange (1)”. After day 21, it is de-escalated to “None” in the illustrated example of Table 7. One could, as an alternative, set the current alert level after day 21 to “Yellow (2)” or “Yellow (1)”, and again de-escalated on day 22 if no breach is detected even without actually issuing an alert, so that the system alert level will be more quickly, or even immediately, escalated if another breach is detected before the counter has fully reset to “None”. Again, such choices are available to and are at the discretion of the system designer and/or the operator.

The skilled person will immediately observe that the comparison in column 4 of Table 7 shows a very significant increase in sensitivity when compared both with column 3 and, more importantly, with the published guideline methods of Table 3. It will be recalled that Table 3 did not show any flags being raised throughout the ten day period of clinical deterioration from days 18-27. In contrast, the comparison in column 4, Table 7, with a metric based on the seven day moving average demonstrates that the patient would have received five yellow and three orange flags during this period, and perhaps more crucially, would have received a yellow flag two days earlier, perhaps encouraging the patient to consult a medical professional, or to increase a dosage of diuretic in accordance with prior instructions from a medical professional.

The fifth column in Table 7 (“vs. 7D 99%CI”) compares the daily weight with the 7 day 99% confidence interval (i.e. the data from column 6 of table 5). While there are, as would be expected, some minor differences in the values of columns 4 and 5 of Table 7, these are not such as to give rise to any differences in the days on which flags would have been generated, or in the values of such flags.

A further and very significant increase in sensitivity can be observed when one compares the daily weight measurement with confidence intervals based on a 14 day rather than a 7 day moving average, as seen in columns 6-8 of Table 7, which make the relevant comparisons with the data from columns 5-7 respectively of Table 6.

For the comparisons with the upper limit thresholds of the 95% and 99% confidence intervals for a 14 day moving average (columns 6 and 7) the relevant threshold is breached continually from day 15 until day 27. In other words, an alert would be generated every day beginning three days before the patient in this case actually attended outpatient treatment in hospital, and because of the escalation system being used, where the third consecutive breach automatically escalates from yellow to orange or orange to red, the patient or doctor would have received an orange alert on days 17 and 18, and red alerts from day 19 onwards until the patient had stabilised. It will be appreciated that while this particular patient received outpatient treatment, such an alerting system provides major advantages where a patient would otherwise not be motivated to seek medical attention, perhaps due to uncertainty or due to symptoms being masked by other health problems.

The data from column 8, Table 7, are quite similar to those from columns 6 and 7, with the comparison being made with the 99.9% confidence interval of the 14 day moving average. The only observable effect, as regards the alerts generated, is that the patient will not have received a yellow alert until day 16, and the escalations happen one day later as a result.

It is to be noted that the 14 day moving average shows a further significant increase in sensitivity over the 7 day moving average, suggesting that it is more suitable for patients at higher risk or where closer monitoring of anomalies is desired.

Table 8 shows a further alternative set of comparisons, in which three streams of comparison are carried on in parallel, as previously discussed, namely a comparison with first, second and third threshold amounts above the 7 day moving average. These threshold amounts are 1, 1.5 and 2 standard deviations respectively (columns 3-5, respectively, derived from the data in columns 3 and 4 of Table 5).

Any breach of threshold in column 3 gives rise to a yellow flag on the first occurrence, escalating to orange and red as before. A breach of the column 4 threshold is more serious and gives an immediate orange flag, which would escalate to red on the third successive day. A breach in column 5 (which does not in fact occur) would give an immediate red flag.

In addition to days 14-29, the data are also shown for days 43-45 when the second deterioration occurred for this patient.

TABLE 8
Weight gain above or below 7 day moving average plus 1, 1.5 or
2 standard deviations, and associated flags, days 14-23 & 43-45

| | | vs. 7 | vs. 7 | vs. 7 | Flag |
|---|---|---|---|---|---|
| | | D MA + | D MA + | D MA + | indicated |
| Day | Weight | 1 SD | 1.5 SD | 2 SD | for day |
| 14 | 78.5 | −0.6 | −0.8 | −0.9 | |
| 15 | 78.9 | −0.2 | −0.4 | −0.5 | |
| 16 | 79.3 | +0.1 Y | −0.0 | −0.2 | Y |
| 17 | 79.2 | −0.0 | −0.2 | −0.3 | |
| 18* | 79.6 | +0.2 Y | +0.0 | −0.2 | Y |
| 19* | 80.0 | +0.3 Y | +0.0 | −0.2 | Y |
| 20* | 80.3 | +0.3 O | −0.0 | −0.3 | O |
| 21* | 80.0 | −0.1 | −0.4 | −0.6 | |
| 22* | 81.0 | +0.5 Y | +0.2 O | −0.2 | O |
| 23* | 80.4 | −0.2 | −0.5 | −0.8 | |
| 24* | 80.9 | +0.1 Y | −0.2 | −0.4 | Y |
| 25* | 81.4 | +0.3 Y | +0.0 | −0.3 | Y |
| 26* | 81.8 | +0.3 O | +0.0 | −0.3 | O |
| 27* | 82.0 | +0.2 O | −0.2 | −0.5 | O |
| 28 | 80.8 | −1.0 | −1.2 | −1.5 | |
| 29 | 78.5 | −3.5 | −4.1 | −4.7 | |
| 43 | 78.4 | −1.2 | −1.4 | −1.7 | |
| 44* | 79.4 | −0.3 | −0.6 | −0.8 | |
| 45* | 81.1 | + 0.8 Y | +0.3 O | −0.1 | O |

On each day, therefore, there is the possibility of a flag being indicated independently according to each of the three criteria, and the actual alert which would be generated by the system for that day is shown in the final column, as the most severe flag indicated for that day across all columns, so that yellow flags are generated on days 16, 18, 19, 24 and 25 with orange flags generated on days 20, 22, 26, 27 and 45.

Note that the orange flag on day 20 arises from the escalation of the alert on days 20 and 21 due to the 1 SD criterion continuing to be exceeded, whereas the orange flag on day 22 arises from the weight gain being sufficiently large to exceed the 1.5 SD criterion, even though column 3 indicates a yellow flag for that day.

Table 9 shows a currently preferred method, in which the comparison is again conducted across three streams of comparison data, this time being the 1, 1.5 and 2 SD thresholds above the 14 day moving average (columns 3-5 of Table 9, derived from the data in columns 3 and 4 of Table 6).

TABLE 9
Weight gain above or below 14 day moving average plus 1, 1.5 or
2 standard deviations, and associated flags, days 14-23 & 43-45

| | | vs. 14 | vs. 14 | vs. 14 | Flag |
|---|---|---|---|---|---|
| | | D MA + | D MA + | D MA + | indicated |
| Day | Weight | 1 SD | 1.5 SD | 2 SD | for day |
| 14 | 78.5 | −0.4 | −0.6 | −0.8 | |
| 15 | 78.9 | −0.1 | −0.2 | −0.4 | |
| 16 | 79.3 | +0.2 Y | +0.0 | −0.2 | Y |
| 17 | 79.2 | +0.1 Y | −0.1 | −0.3 | Y |
| 18* | 79.6 | +0.3 O | +0.1 O | −0.1 | O |
| 19* | 80.0 | +0.5 O | +0.3 O | +0.0 | O |
| 20* | 80.3 | +0.6 R | +0.3 R | +0.0 | R |
| 21* | 80.0 | +0.2 R | −0.1 | −0.4 | R |
| 22* | 81.0 | +0.9 R | +0.5 O | +0.2 R | R |
| 23* | 80.4 | +0.2 R | −0.2 | −0.5 | R |
| 24* | 80.9 | +0.5 R | +0.1 O | −0.3 | R |
| 25* | 81.4 | +0.7 R | +0.2 O | −0.2 | R |
| 26* | 81.8 | +0.8 R | +0.3 R | −0.2 | R |
| 27* | 82.0 | +0.7 R | +0.1 R | −0.4 | R |
| 28 | 80.8 | −0.6 | −1.0 | −1.5 | |
| 29 | 78.5 | −2.9 | −3.4 | −3.9 | |
| 43 | 78.4 | −1.1 | −1.4 | −1.8 | |
| 44* | 79.4 | −0.2 | −0.5 | −0.8 | |
| 45* | 81.1 | +1.2 Y | +0.8 O | +0.4 R | R |

This comparison method is again more sensitive, showing a red flag in column 5 on days 22 and 45, a red flag in column 4 on days 20, 26 and 27 (due to escalation from orange) and a red flag in column 3 on days 20-27 inclusive (due to escalation from yellow through orange to red).

The net effect, i.e. the actual alert issued by the system, is shown in column 6 of Table 9, which indicates a gradual escalation from yellow alert on day 16 (two days before the patient's first day of outpatient attendance at hospital), to orange on day 18, and to red on day 20.

Thus it can be seen that each of the comparisons with 7 day or 14 day moving average data gives greatly increased sensitivity relative to the standard guideline methods of weight comparison.

Table 9 shows the comparative efficacy of each such system, bringing together the alerts indicated from each of Tables 3, 7, 8 and 9, but expanded to show the full set of alerts over days 1-45. The columns in Table 11 are labelled with the table number and column number from which they derive the data. Thus the fourth column of Table 11 is labelled 3(2), indicating that it summarises the alerts from Table 3, column 2—the comparison with the guideline method of monitoring for a 2 kg weight increase over 2 days. A full key to the column labels is provided below Table 11.

TABLE 11
Summary of flag alerts using different detection methods days 1-45

| Day | Weight | 3 (1) | 3 (2) | 3 (3) | 7 (3) | 7 (4) | 7 (5) | 7 (6) | 7 (7) | 7 (8) | 8 (6) | 9 (6) |
|---|---|---|---|---|---|---|---|---|---|---|---|---|
| 1 | 77.8 | | | | | | | | | | | |
| 2 | 78.3 | | | | | | | | | | | |
| 3 | 78.0 | | | | | | | | | | | |
| 4 | 78.4 | | | | | | | | | | | |
| 5 | 78.9 | | | | | | | | | | | |
| 6 | 78.6 | | | | | | | | | | | |
| 7 | 78.3 | | | | | | | | | | | |
| 8 | 78.3 | | | | | | | | | | | |
| 9 | 78.3 | | | | | | | | | | | |
| 10 | 79.1 | | | | | x | | | | | xx | x |
| 11 | 79.1 | | | | | x | | | | | x | x |
| 12 | 78.9 | | | | | | | | | | | |
| 13 | 78.9 | | | | | | | | | | | |
| 14 | 78.5 | | | | | | | | | | | |
| 15 | 78.9 | | | | | | | x | x | | | |
| 16 | 79.3 | | | | | x | x | x | x | x | x | x |
| 17 | 79.2 | | | | | | | xx | xx | x | | x |
| 18* | 79.6 | | | | | x | x | xx | xx | xx | x | xx |
| 19* | 80.0 | | | | | x | x | xxx | xxx | xx | x | xx |
| 20* | 80.3 | | | | | xx | xx | xxx | xxx | xxx | xx | xxx |
| 21* | 80.0 | | | | | | | xxx | xxx | xxx | | xxx |
| 22* | 81.0 | | | | | x | x | xxx | xxx | xxx | xx | xxx |
| 23* | 80.4 | | | | | | | xxx | xxx | xxx | | xxx |
| 24* | 80.9 | | | | | x | x | xxx | xxx | xxx | x | xxx |
| 25* | 81.4 | | | | | x | x | xxx | xxx | xxx | x | xxx |
| 26* | 81.8 | | | | | xx | xx | xxx | xxx | xxx | xx | xxx |
| 27* | 82.0 | | | | | xx | xx | xxx | xxx | xxx | xx | xxx |
| 28 | 80.8 | | | | | | | | | | | |
| 29 | 78.5 | | | | | | | | | | | |
| 30 | 77.9 | | | | | | | | | | | |
| 31 | 77.5 | | | | | | | | | | | |
| 32 | 78.2 | | | | | | | | | | | |
| 33 | 78.7 | | | | | | | | | | | |
| 34 | 78.8 | | | | | | | | | | | |
| 35 | 79.8 | | | | | x | x | | | | | |
| 36 | 79.3 | | | | | x | | | | | | |
| 37 | 78.7 | | | | | | | | | | | |
| 38 | 79.5 | | | | | x | | | | | | |
| 39 | 79.7 | | | | | x | | | | | | |
| 40 | 79.4 | | | | | | | | | | | |
| 41 | 79.0 | | | | | | | | | | | |
| 42 | 78.2 | | | | | | | | | | | |
| 43 | 78.4 | | | | | | | | | | | |
| 44* | 79.4 | | | | | | | x | | | | |
| 45* | 81.1 | xxx | xxx | xxx | | x | x | x | x | x | xx | xxx |

Yellow Alert: x
Orange Alert: xx
Red Alert: xxx

In Table 11, for ease of visual comparison, the indicators “Y”, “O” and “R” for the first, second and third forms of alert (yellow, orange and red) have been replaced by a one star, two star, three star indicator, with increasing numbers of stars denoting more severe alerts.

### Expanded Explanation of Column Labels in Table 11:

| Column | Source of comparison | Flag & Criteria |
|---|---|---|
| 3(1) | Table 3, column 1 | Red if >1.4 kg in 1 day |
| 3(2) | Table 3, column 2 | Red if >2 kg in 2 days |
| 3(3) | Table 3, column 3 | Red if >2.2 kg in 3 days |
| 7(3) | Table 7, column 3 | Yellow if >3 D 95% CI, escalating on third occurrences |
| 7(4) | Table 7, column 4 | Yellow if >7 D 95% CI, escalating on third occurrences |
| 7(5) | Table 7, column 5 | Yellow if >7 D 99% CI, escalating on third occurrences |
| 7(6) | Table 7, column 6 | Yellow if >14 D 95% CI, escalating on third occurrences |
| 7(7) | Table 7, column 8 | Yellow if >14 D 99% CI, escalating on third occurrences |
| 7(8) | Table 3, column 3 | Yellow if >14 D 99.9% CI, escalating on third occurrences |
| 8(6) | Table 8, column 6 | The most severe of: |
| | | (1) Yellow if >7 DMA + 1SD, escalating on third occurrences |
| | | (2) Immediate Orange if >7 DMA + 1.5SD, escalating on third |
| | | occurrences |
| | | (3) Immediate Red if >7 DMA + 2SD |
| 9(6) | Table 9, column 6 | The most severe of: |
| | | (1) Yellow if >14 DMA + 1SD, escalating on third occurrences |
| | | (2) Immediate Orange if >14 DMA + 1.5SD, escalating on third |
| | | occurrences |
| | | (3) Immediate Red if >14 DMA + 2SD |

The summary data in Table 11 shows that the best results, in terms of sensitivity to both deteriorations in the patient's health, begin with column 7(4), i.e. all of the comparisons against thresholds calculated against moving averages for at least 7 days show very good results. The best results are seen in the 14 day moving average data.

The 7 day moving average data in columns 7(4) and 7(5) show alerts in the period from day 35-39. This is likely to be due to decreased specificity (i.e. identification of false positives).

Columns 7(4), 8(6) and 9(6) show alerts on days 10-11. Whether this is due to an early forewarning of the events seen from days 15/16 onwards or whether they are false positives is not known, but the fact that they were closely followed by a significant decompensation suggests that such alerts are worth generating, particularly for at-risk patients.

Clinical Study & Comparison with Accepted Guideline Monitoring Protocols

In an ongoing clinical study involving 111 patients who consented to one of three arms, data were collected representing more than 300 patient-months follow-up. In addition, we carried out an audit of a control group of 40 patients who did not consent to participate in the remote telemonitoring study. Therefore, a large majority (74%) of patients are happy to participate in a clinical trial with remote telemonitoring based on familiar, automated mobile phone technology.

The study population was typical of a hospital heart failure population (average age 72.8 +/−9.0 years, 71% male, 81% LVSD, 67% previous myocardial infarction). At baseline, systolic blood pressure was 118 +/−17 mmHg, diastolic blood pressure was 70 +/−11 mmHg and heart rate was 67 +/−12 bpm. Average ejection fraction was 35+/−14% and BNP at baseline was 713 pg/mL +/−715 pg/mL (median 500 pg/mL) which underlines the high risk nature of the selected population. The selected population was on optimal evidence based medication with 88% taking ACE inhibitors, 21% taking angiotensin receptor blockers, 100% taking beta blockers and 47% taking aldosterone blockers. The results were analysed on the basis of the following 3 approaches and monitoring extended to an average of 3.1 months:

### [Approach 1]

Usual care with manual patient weight monitoring linked to a specialist heart failure unit and without remote telemonitoring (n=30)

### [Approach 2]

Remote telemonitoring with use of discharge weight as baseline and with protocol driven responses to Guideline increases in daily weight (n=39).

### [Approach 3]

Remote telemonitoring without clinical intervention based on weight in order to assess the performance of published Guideline versus the method of the invention with gradated weight alerts in a controlled environment (n=42).

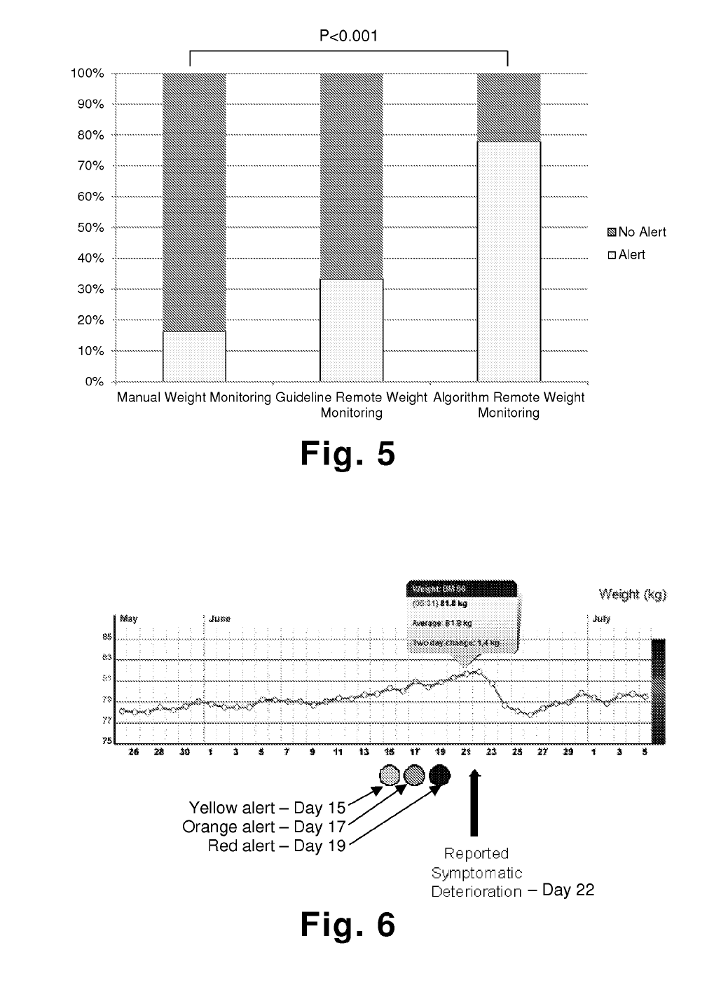

FIG. 5 illustrates the sensitivity of each of the three approaches in terms of patients experiencing clinical deteriorations within each group. The three bars in FIG. 5, from left to right, represent Approaches 1, 2 and 3 respectively. Thus Approach 1, labelled “Manual Weight Monitoring” and Approach 2, labelled

“Guideline Remote Weight Monitoring” represent the sensitivity of the Guideline approaches when based on patient self-monitoring and remote monitoring, respectively. The right-most bar, labelled “Algorithm Weight Monitoring” represents the method of the invention, i.e. the sensitivity of the method involving moving-average calculations and deviations from that average:

The documented experience of weight monitoring in heart failure and the results to date of the clinical study demonstrate a number of important issues.
[1] The conventional guideline approach where patients manually self-monitor weight and report 2 kg weight gain over 2-3 days [Approach 1 above] has a sensitivity for clinical deterioration of only 16% (FIG. 5). In addition, it is associated with weight monitoring non-adherence of 1 in 3 patients measured separately by analysis of patient manual weight monitoring booklets.
[2] The conventional guideline approach when implemented using remote monitoring, improves detection of deterioration (defined as an alert within 7 days of clinical deterioration) in 33% of cases (FIG. 5). However, in this instance, it is not significantly better than manual weight monitoring.
[3] The method described herein as an approach to weight monitoring improves the detection of clinical deterioration to 77% of cases (FIG. 5) and this is significantly better than manual weight monitoring (p<0.001). In the cases of clinical deterioration for heart failure that were not picked up by the weight monitoring method described herein, one patient was severely ill and died 4 days after discharge and only used the remote patient monitoring system for 2 days; a second patient suffered an acute myocardial infarction, was brought to hospital and developed heart failure subsequently. In these circumstances, the remote weight monitoring method described herein would not be relevant. In addition, the method described herein identified significantly more non-heart failure hospitalisations compared to the guideline approach. In certain cases, using a 7 day vs. 14 day moving average reduces the sensitivity of the guideline approach for alerts. However, using the 7 day moving average does not result in loss of sensitivity for actual deteriorations and has a tendency to identify deteriorations earlier than the 14 day moving average approach. A further observation is that by grouping the daily alerts in to continuous events it is possible to reduce the number of average contacts per patient per month to 1.75 (i.e. if weight is climbing over a 3 consecutive day period, it is possible to reduce the need for patient contact from 3 days to a single contact, particularly if the weight change is asymptomatic). These points serve to validate the approach to weight monitoring in heart failure offered by the method described herein and is also illustrated in an example in FIG. 6.

FIG. 6 provides an illustrative example of the value of the weight monitoring method described herein in detecting heart failure deterioration. In this case, the method described herein alerts the weight change as a yellow alert (“observe”) 7 days before the deterioration (first dot on Figure), an orange alert (“contact and consider intervention”) 5 days before the deterioration (second dot on Figure), and a red alert (“contact and consider intervention/clinic review”) 3 days before the clinical deterioration (third dot on Figure). The Guideline approach would not have triggered an alert at any point before this actual clinical deterioration occurred on day 22.
[4] A further unanticipated observation from the clinical study was that the Guideline approach generates 0.47 alerts per patient monitored per month. To date, more than 90% of these alerts are not associated with clinical deterioration of heart failure. Therefore, unlike previously published work on weight changes in heart failure (Lewin J et al. European Journal of Heart Failure volume 7 (2005) 953-957), in controlled studies, guideline weight alerts are not specific for heart failure deterioration.
[5] A further point of value of the method described herein is illustrated by the fact that as well as a tiered response to the weight change, facilitating patient contact and evaluation of patient reported outcomes, the method described herein alerts the need for patient contact and possible intervention for heart failure deteriorations on average more than 2 days before the deterioration commences. From our clinical study work, in the few occasions that the Guideline alerts to the deterioration, the guideline alert occurs during the deterioration.

There is a significant advantage to the patient and clinical team in early alerts for clinical deterioration. Conversely, alerts generated to the clinical care team during the deterioration, as appears to be the case with the guideline alerts, are less valuable than alerts which afford the opportunity for preventative measures.
[6] It was anticipated that the method described herein would effectively track changes in an individual's stable weight. This was anticipated as a major benefit of the method described herein and was counter to the prevailing expert view and also landmark published studies on weight monitoring in heart failure (Chaudhry S et al. Circulation 2007;116;1549-1554; originally published online Sep. 10, 2007). In that work, the authors demonstrated that in a large population of patients who deteriorate and require hospitalisation for heart failure versus those who did not, there appears to be a stable underlying patient weight. This work has reinforced a prevailing expert approach which is a modification/simplification of the guideline approach, wherein weight alerts are generated from the baseline stable weight. In other words, should a patient exceed 2 kg from baseline, an intervention would be warranted. In the example provided for above in FIG. 2, this approach would be useful because the underlying stable weight appeared only to change during clinical deterioration.

A further modification of this expert approach is used in the largest randomised controlled trial of remote monitoring of heart failure, recently published in the New England Journal of Medicine, (Chaudhry S et al, N Engl J Med 363;24 nejm.org Dec. 9, 2010) where weight alerts are generated using a threshold of 3 lb (just over 1 kg) from baseline. Although the threshold is different, the approach is similar and assumes, as the Circulation 2007 publication would appear to suggest, that baseline weight is stable.

In our clinical study we evaluated this expert approach in Approach 2.

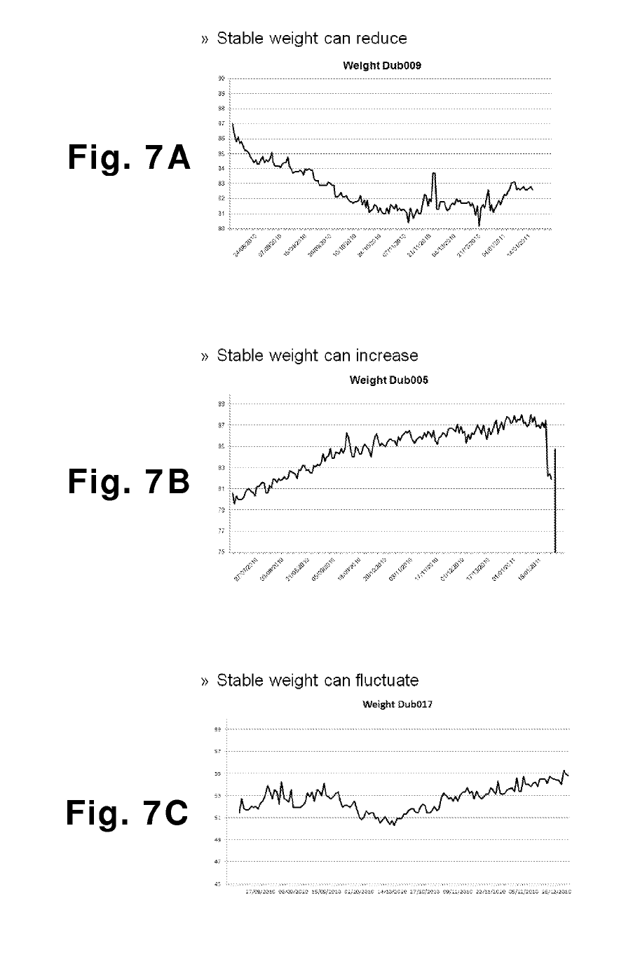

Surprisingly, in the large majority (84% of studied cases), the stable weight climbed more than 2 kg above or below the baseline weight within the monitoring period. Representative examples of the cases are provided in FIGS. 7A, 7B and 7C showing illustrative examples of varying individual patterns of underlying stable weight change in 3 patients who did not deteriorate due to heart failure during the clinical study, and whose underlying stable weight increased, decreased and fluctuated respectively. In all patients observed, a large majority (84%) had underlying weight changes of >2 kg from baseline weight. This highlights the inherent flaw of prevailing expert approaches to weight monitoring in heart failure which use baseline stable weight as the basis for calculating weight alerts. This is counter to the prevailing view of experts in this area and it dramatically validates the approach of the method described herein for tracking individual patient weights rather than assuming that baseline weight is stable.

Furthermore, it highlights a fundamental flaw in the prevailing expert view which is also tested in Approach 2 of our study. We observed a large number of apparent heart failure deteriorations (0.246 per patient monitored per month), mostly triggered by weight gain of >2 kg, compared to usual care (0.173 per patient per month) in this prevailing expert view. This may help explain why the large, randomised study of this approach published in the NEJM surprisingly failed to demonstrate any patient benefit.

This tendency for underlying stable weight to change in a majority of individual heart failure patients and the ability of the patent algorithm to track this underlying change represents a major advance in the understanding of weight monitoring in heart failure. It can be rationalised in the context of the published data provided in the Chaudhry et al. Circulation 2007 publication as follows: when large bodies of data are aggregated, the underlying stable weight does not significantly change except during deterioration. This arises, we believe from our study, because as many patients increase as decrease underlying stable weight. However, when applied to individual patients, the vast majority undergo large changes in underlying stable weight which renders the modified, prevailing expert approach fundamentally flawed. Indeed, this would render alerts, whether based on the 2 kg or 3 lb thresholds, of almost no value, with a large proportion of patients unable to ever reach the alert threshold and another group of patients constantly breaching alert thresholds. Indeed, it might accordingly create inappropriate interventions based on weight change or generate loss of confidence in the sensitivity of the system to generate alerts. The individualised approach of the patent algorithm is accordingly validated.
[7] To date, the overall death and heart failure event rate in our clinical study of patients undergoing usual care is 0.187 per patient monitored per month. The use of remote patient monitoring is associated with an anticipated reduction of death and heart failure event rates to 0.048 per patient monitored per month(p<0.05 vs. usual care). Further improvements in heart failure event rates by early intervention in up to 77% of events using the patent algorithm are anticipated. This additional benefit in early detection of heart failure deterioration can be further improved by industry standard biomarkers such as BNP, blood pressure, heart rate, impedance measurements and patient reported outcomes. The following are the daily patient reported outcomes evaluated as part of the clinical work:
1. Did you feel worse over the past 24 hours?
2. Did a difficulty in your breathing cause you to wake last night?
3. Did you require extra pillows to sleep comfortably last night?
4. Was your breathing worse over the last 24 hours?
5. Did you notice any increase in ankle or leg swelling in the past 24 hours?
6. Is dizziness or light-headedness a new symptom that has occurred in the last 24 hours?
7. Did you take all your prescribed medication yesterday?

Each question requires a yes/no answer for ease of use. These questions allow an improvement in the sensitivity and specificity of the patent algorithm detection of deterioration. In addition, it reduces the workload associated with false positives. In the case of a positive answer from question 2, high suspicion of clinical deterioration associated with weight changes over a 7 day period is warranted.

1. A method of evaluating a subject's weight comprising the steps of:
(a) maintaining a record containing a historical set of indications of the weight of the subject;
(b) receiving a new indication of the weight of the subject;
(c) adding the new indication to the record;
(d) calculating a moving average of the weight of the subject based at least on a plurality of indications in the record immediately preceding the new indication;
(e) comparing the new indication with the calculated moving average;
(f) generating a first form of alert if the new indication differs from the calculated moving average by more than a threshold amount;
(g) iteratively repeating steps (b) to (f) for subsequently received new indications and, if said first alert is generated consecutively on a predetermined number of successive iterations, generating a second form of alert different from the first form of alert.

2. The method of claim 1 wherein the calculation of the moving average is a simple moving average calculation.

3. The method of claim 1, wherein the iterations occur on consecutive days, with the moving average providing a measure of the average weight of the subject over a predetermined number of days.

4. (canceled)

5. The method of claim 1, wherein the moving average is calculated as the moving average based on the previous 7 or more measurements.

6. The method of claim 5, wherein the moving average is calculated as the moving average based on the previous 10 or more measurements, more preferably on the previous 14 measurements.

7. The method of claim 1, wherein the threshold amount is calculated as a statistical metric indicative of the distribution of a plurality of indications in the record based on one or more of: a measure of variance, standard deviation, probability distribution, or interval estimation such as confidence interval or Bayesian interval.

8. (canceled)

9. The method of claim 7, wherein the plurality of indications in the record employed to calculate said statistical metric is the same plurality of indications on which the moving average calculation is based.

10. The method of claim 1, wherein the threshold amount is calculated as a predetermined multiple of the standard deviation of the set of measurements from which the moving average is calculated.

11. The method of claim 10, wherein the threshold is one standard deviation.

12. The method of claim 1, wherein if the new indication differs from the calculated moving average by more than an elevated threshold amount, the second form of alert is generated instead of the first form of alert.

13. The method of claim 11, wherein the elevated threshold amount is 1.5 times the standard deviation.

14. The method of claim 1, further comprising the step of issuing a third form of alert if the second form of alert is repeated on a predetermined number of successive iterations.

15. The method of claim 1, wherein a further elevated threshold is defined which, if breached, causes a third form of alert to issue immediately without escalating through the first and second forms of alert.

16. The method of claim 1, wherein the number of consecutive instances of the first form of alert required to generate the second form of alert is 2 or 3.

17. The method of claim 14, wherein the number of consecutive instances of the second form of alert required to generate the third form of alert is 2 or 3.

18. The method of claim 1, wherein the threshold, elevated threshold, or further elevated threshold (if defined) is calculated as being a limit of a confidence interval for the data set used to generate the moving average.

19. The method of claim 1, wherein the calculation of moving average includes not only the plurality of indications in the record immediately preceding the new indication, but also the new indication itself.

20. (canceled)

21. A computer-implemented method of evaluating a subject's weight, comprising the following steps carried out in a computer system:
(a) maintaining a record containing a historical set of indications of the weight of the subject;
(b) receiving as an input to the computer system a new indication of the weight of the subject;
(c) adding the new indication to the record;
(d) calculating, using a processor of the computer system, a moving average of the weight of the subject based at least on a plurality of indications in the record immediately preceding the new indication;
(e) comparing the new indication with the calculated moving average;
(f) generating at an output of the computer system a first form of alert if the new indication differs from the calculated moving average by more than a threshold amount;
(g) iteratively repeating steps (b) to (f) for subsequently received new indications and, if said first alert is generated consecutively on a predetermined number of successive iterations, generating at an output of the computer system a second form of alert different from the first form of alert.

22. A system for evaluating a subject's weight, comprising:
(a) a record containing a historical set of indications of the weight of the subject;
(b) an input for receiving a new indication of the weight of the subject;
(c) an updating mechanism for adding the new indication to the record;
(d) a processor programmed to:
(i) calculate a moving average of the weight of the subject based at least on a plurality of indications in the record immediately preceding the new indication;
(ii) compare the new indication with the calculated moving average; and
(iii) generate a first form of alert if the new indication differs from the calculated moving average by more than a threshold amount;
(iv) iteratively repeat steps (i) to (iii) for subsequently received new indications and, if said first alert is generated consecutively on a predetermined number of successive iterations, to generate a second form of alert different from the first form of alert;
(e) one or more outputs for communicating said first and second alerts.

23. A method of evaluating a subject's weight comprising the steps of:
(a) maintaining a record containing a historical set of indications of the weight of the subject;
(b) receiving a new indication of the weight of the subject;
(c) adding the new indication to the record;
(d) calculating a moving average of the weight of the subject based at least on a plurality of indications in the record immediately preceding the new indication;
(e) comparing the new indication with the calculated moving average;
(f) generating a first form of alert if the new indication differs from the calculated moving average by more than a first threshold amount;
(g) generating a second form of alert different from the first form of alert if the new indication differs from the calculated moving average by more than a second threshold amount, the second threshold amount being greater than the first threshold amount; and
(h) iteratively repeating steps (b) to (g) for subsequently received new indications and, if said first alert is generated consecutively on a predetermined number of successive iterations, generating said second form of alert, even if the new indication does not differ from the calculated moving average by more than said second threshold amount.

24. (canceled)

25. (canceled)
